(19) United States
(12) Patent Application Publication
(10) Pub. No.: US 2006/0156370 A1
(43) Pub. Date: Jul. 13, 2006

(54) Method and arrangement for indicating requirements for broadcast and multicast reception

(76) Inventor: Janne Parantainen, Helsinki (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 10/529,705

(22) PCT Filed: Oct. 2, 2003
(86) PCT No.: PCT/FI03/00718

§ 371 Date: Oct. 12, 2005

(30) Foreign Application Priority Data
Oct. 2, 2002 (FI) 20021755

(51) Int. Cl. H04N 7/173; G06F 3/00; G06F 13/00; H04N 7/16; H04N 5/445

(52) U.S. Cl. 725/132; 725/140; 725/50

(57) ABSTRACT

The invention relates to a method and an arrangement for indicating requirements for broadcast and multicast service reception. A basic method comprises a step of transmitting a message indicating the requirements over the air interface to terminals within the service range. An alternative method comprises a step of informing the terminal's capabilities to the system which deduces on the basis of informed data whether the terminal is capable of joining the service or not. A wireless system comprising a network element and at least one wireless terminal operable in the system is presented. The wireless terminal is capable of receiving the broadcast message indicating the requirements and sending a capability notification. The network element is capable of receiving the notification and sending the message indicating the requirements. Service requirements and corresponding terminal capabilities are divided into a number of capability classes which can be announced instead of explicit data.

The present invention relates generally to telecommunication systems. In particular the invention concerns broadcast and multicast services in wireless systems such as mobile networks.

The terms “broadcast” and “multicast” refer to methods for transmitting data from a single sender to several recipients. In broadcast services basically all users connected to the system can in principle, if equipped with a terminal providing sufficient capabilities, receive the data if they have enabled the service reception on their UE (User Equipment) and are located in service range. In multicast services only the users who have subscribed to a certain multicast group can receive the data associated with said group.

Traditionally aforesaid point-to-multipoint services in fixed networks, e.g. multicast services on the Internet, have provided only minor benefits what comes to the resource saving aspects related to the amount of transferred data. Now, the advent of modern mobile networks has introduced considerable advantages for resource sharing resulting also better overall efficiency because the subscribers of a certain service can receive the same data on a common channel thus saving both network and radio resources such as time slots, carrier frequencies or hopping sequences. One essential difference between fixed and mobile networks is admittedly that efficient bandwidth usage is much more critical factor in mobile networks as radio frequencies seem to be the scarce resource, and transmission capacity of fixed networks can be increased more painlessly after all.

3GPP (3^{rd} Generation Partnership Project) has recently published a specification for the 3GPP system comprising either UTRAN (UMTS Terrestrial Radio Access Network) or GERAN (GSM/EDGE Radio Access Network) as a radio access network. The specification defines a new broadcast/multicast service titled MBMS (Multimedia Broadcast/Multicast Service) [1].

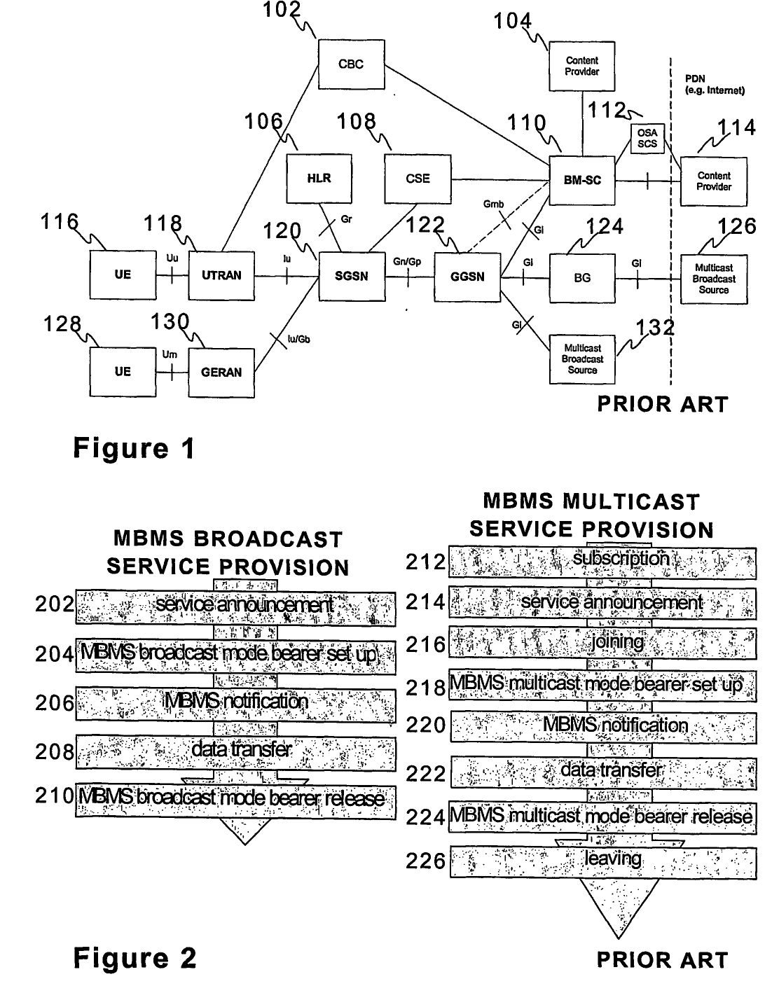

MBMS basic architecture is illustrated in FIG. 1 wherein CBC (Cell Broadcast Centre) 102, CSE (Camel Service Environment) 108, OSA/SCS (Open Service Access) 112 and related reference points can be considered as optional functionalities. Accordingly, mandatory components for realizing a MBMS service are described next in reference to [2].

The SGSN (Serving GPRS Support Node) 120 executes user individual service control functions, concentrates individual users of the same MBMS service into a single MBMS service and maintains a single connection with the source of the MBMS data. The GGSN (Gateway GPRS Support Node) 122 terminates the MBMS GTP (GPRS Tunneling Protocol) tunnels from the SGSN and links these tunnels via IP (Internet Protocol) multicast with the MBMS data source. The BM-SC (Broadcast/Multicast Service Center) 110 is a MBMS data source. MBMS data may be scheduled in the BM-SC 110 to be e.g. transmitted to the user every hour. It offers interfaces which can be utilized by the content provider 114 in requesting data delivery to users. The BM-SC 110 may authorise and charge content provider 114. The Gmb reference point between BM-SC 110 and GGSN 122 enables the BM-SC 110 to exchange MBMS service control information with the GGSN 122. The Gmb reference point exists in order to carry the MBMS Service information but it may not always be necessary to use the Gmb for each service. MBMS service can be delivered to user equipment (UE) 116, 128 such as a mobile terminal over GERAN 130 or UTRAN 118. The SGSN authenticates users and authorises the usage of services based on subscription data from HLR 106.

The architecture also accepts other MBMS broadcast/multicast data sources and internal data sources 104 may directly provide their data. Data delivery by external sources 126 is controlled by Border Gateways (BG) 124 which may allow for example data from single addresses and ports to pass into the PLMN (Public Land Mobile Network) for delivery by an MBMS service.

The architecture assumes the use of IP multicast at the reference point Gi. The MBMS data source has only one connection to the IP backbone. The reference point from the content provider to the BM-SC 110 is currently not standardized as it might become too complex or too restrictive for service creation. For example, this may be a reference point between the BM-SC 110 and an authoring system, or the authoring functionality may be distributed between both entities. The same architecture provides MBMS broadcast services mainly by using the transport functions. The user specific SGSN functions are not required. Instead each individual broadcast service is configured in the SGSN 120.

The SGSN 120 may use CAMEL (Customised Application for Mobile network Enhanced Logic) to handle pre-paid services, e.g. credit checking for on-line charging. The Cell Broadcast Centre (CBC) 102 may be used to announce MBMS services to the users. The BM-SC 110 may exploit OSA-SCS 112 to interact with third parties. For the terminal split, MBMS shall be able to interoperate with an IP multicast client software on the TE.

MBMS broadcast and multicast service provisions are described in FIG. 2. In MBMS broadcast service provision service announcement 202 informs UEs about forthcoming services. MBMS broadcast mode bearer set up 204 establishes the network resources for MBMS data transfer in the broadcast area. MBMS notification 206 informs the UEs about forthcoming (and potentially about ongoing) broadcast data transfer. Data transfer 208 is the phase when MBMS data are transferred to the UEs. MBMS broadcast mode bearer release 210 releases the network resources for MBMS data transfer, e.g. when no more transferable MBMS data exists. Service announcement 202 and MBMS notification 206 steps may run in parallel with other phases, in order to inform UEs which have not yet received the related service.

In MBMS multicast service provision subscription 212 establishes the relationship between the user and the service provider, which allows the user to receive the related MBMS multicast service. Service announcement 214 informs UEs about forthcoming services. Joining (MBMS multicast activation) 216 is the process by which a subscriber becomes a member of a multicast group, i.e. the user indicates to the network that he/she is willing to receive multicast mode data of a specific service. MBMS multicast mode bearer set up 218 establishes the network resources for MBMS data transfer in the multicast area. MBMS notification 220 informs the UEs about forthcoming (and potentially about ongoing) multicast data transfer. During data transfer phase 222 MBMS data is transferred to the UEs. MBMS multicast mode bearer release 224 releases the network resources for MBMS data transfer, e.g. when no more MBMS data has to be transferred. Leaving 226 (MBMS multicast deactivation) is the process by which a subscriber leaves (stops being a member) a multicast group, i.e. the user no longer wants to receive multicast data of a specific service. The phases subscription 212, joining 216 and leaving 226 are performed individually per user. The other phases are performed for a service provision, i.e. for all users associated with the related service.

MBMS service announcement/discovery mechanisms 202, 214 should allow users to request or be informed about the range of MBMS services available. This includes operator specific MBMS services as well as services from content providers outside of the PLMN. Operators/service providers may consider several service discovery mechanisms including standard mechanisms such as SMS, or depending on the capability of the terminal, applications that encourage user interrogation. The method chosen to inform users about MBMS services may have to account for the users location, (e.g. current cell, in the HPLMN or VPLMN). Users who have not already subscribed to a MBMS service should also be able to discover MBMS services. For example SMS-CB (Short Message Service—Cell Broadcast), MBMS Broadcast to advertise MBMS Multicast Service, PUSH mechanisms (WAP, SMS-PP) and Web URL (Universal Resource Locator) can be utilized in service discovery purposes.

More detailed information about MBMS service activation/release models, data transfer, functionalities of network elements, radio interface bearer set-up/release, QoS (Quality of Service), security issues etc. can be found in the references [1] and [2].

Current MBMS specifications don't address UE capability issues in any way. However, for example GSM (Global System for Mobile Communication), GPRS (General Packet Radio Service) and WCDMA (Wideband Code Division Multiple Access) terminals vary significantly what comes to their data reception and transmission capabilities. In GSM and GPRS systems mobile terminals have been actually divided into multislot classes that define the number of time slots a mobile belonging to a certain class can utilize in uplink and downlink directions [3]. Another distinctive factor in the near future will be EDGE (Enhanced Data rates for GSM Evolution) capability, essentially the availability of transmission means supporting 8-PSK (Phase Shift Keying) modulation and enhanced layer 2 retransmission mechanism. Accordingly, in WCDMA the low-end terminals may only support relatively low bit rates such as 128 kbit/s e.g. due to insufficient memory or processing power to receive and decode higher bit rate (e.g. 384 kbit/s or HSDPA, High Speed Downlink Packet Access) video applications etc.

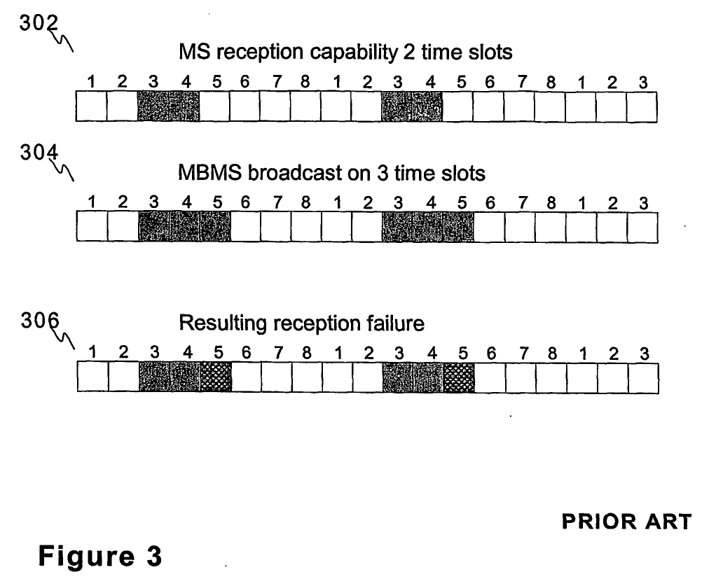

When multimedia broadcast or multicast services are provided to a group of UEs like mobile terminals the data allocation must be done in a way that all terminals belonging to the target group can receive the media stream. See FIG. 3, wherein a terminal is capable of receiving data on two time slots 302. If, for example, in GERAN the media stream is sent on three adjacent time slots per carrier 304, two time slot capable terminals just cannot receive the service 306. Also, if higher data rate is to be provided by using 8 PSK modulation, only the terminals that support EDGE can receive the service. As a consequence, there exists a great demand for defining and notifying about what kind of requirements the terminals must meet in order to be able to receive a particular MBMS service. The same situation applies to UTRAN with terminals providing varying support for bit-rate adaptation and other properties.

An object of the present invention is to provide a feasible and reliable technique for indicating requirements for broadcast and multicast service reception. The object is achieved with a method and a device which either explicitly or implicitly provide that information to a receiving end a priori, before actual attempts by the receiving end to receive overly demanding or otherwise incompatible transmission. Thereby, most error cases can be avoided and average power consumption reduced, as the terminal does not need to monitor the broadcast blocks it cannot receive.

A method according to the invention for indicating one or more terminal capability requirements for point-to-multipoint MBMS service reception in a wireless system is characterized in that in that said method comprises the step of transmitting a broadcast or multicast message indicating said terminal capability requirements over the air interface to at least one terminal within the service range in order to allow the terminal to determine whether it is capable of receiving the service or not, said requirements being indicated in relation to at least one of the following: time slot configuration, modulation type, bit rate, capability class.

In another aspect of the invention, a method for indicating requirements for point-to-multipoint MBMS service reception in a wireless system to be performed by a terminal operable in said system, is characterized in that said method comprises the step informing the terminal's capabilities in relation to at least one of the following: time slot configuration, modulation type, bit rate, and capability class, to said system in order to enable the system to deduce on the basis of informed data whether the terminal is capable of receiving the service or not.

In a further aspect of the invention, a terminal operable in a wireless system, comprising processing means and memory means for processing and storing instructions and data, is characterized in that said terminal is arranged to receive a message indicating requirements for point-to-multipoint MBMS service reception and arranged to determine on the basis of said requirements whether it is capable of receiving the service or not, the requirements indicated in relation to at least one of the following: time slot configuration, modulation type, bit rate, and capability class.

In a further aspect of the invention, a terminal operable in a wireless system, comprising processing means and memory means for processing and storing instructions and data, is characterized in that it is arranged to inform its capabilities in relation to at least one of the following: time slot configuration, modulation type, bit rate, and capability class, to said system for the examination of fulfilment of point-to-multipoint MBMS service reception requirements.

In a further aspect of the invention, a network element operable in a wireless system, comprising processing means and memory means for processing and storing instructions and data, is characterized in that it is arranged to send a message indicating requirements in relation to at least one of the following: time slot configuration, modulation type, bit rate, and capability class, for point-to-multipoint MBMS service reception to be delivered to at least one wireless terminal within the service range in order to allow said wireless terminal to determine whether it is capable of receiving the service or not.

In a further aspect of the invention, a network element operable in a wireless system, comprising processing means and memory means for processing and storing instructions and data, is characterized in that it is arranged to receive a notification from a terminal in relation to at least one of the following: time slot configuration, modulation type, bit rate, and capability class, and deduce on the basis of said notification whether the terminal is capable of receiving a point-to-multipoint MBMS service or not.

A system according to the invention comprises a network element and at least one wireless terminal operable in said system, and the system is characterized in that said network element comprises means for sending a message indicating requirements for point-to-multipoint MBMS service reception in relation to at least one of the following: time slot configuration, modulation type, bit rate, and capability class, to be delivered to at least said wireless terminal within the service range and said terminal comprises means for receiving said broadcast message indicating requirements for point-to-multipoint service reception and means for determining on the basis of said indication whether it is capable of receiving the service or not.

In one embodiment of the invention a system already comprising CBS (Cell Broadcast Service) is supposed to support more versatile MBMS services as well and notify terminals in-range about the requirements for service reception in conjunction with sending a CBS schedule message disclosing data about MBMS services instead. In practise, the requirements are notified by informing the terminals about an applicable MBMS capability class. Three different capability classes define the minimum capabilities required for receiving available services.

In another embodiment of the invention a mobile terminal capable of receiving point-to-multipoint services informs the system it is connected to about its capabilities such as a maximum number of concurrently receivable downlink time slots for joining a certain MBMS multicast service. The system checks if necessary minimum requirements for the joining/service reception are met and if that is the case, accepts the joining request and if not, rejects it.

The accompanying dependent claims describe some embodiments of the invention.

In the following, the invention is described in more detail by reference to the attached drawings, wherein

FIG. 1 is a block diagram of a MBMS capable system as referred to in the description of the background of the invention.

FIG. 2 depicts provision of MBMS broadcast and multicast services as presented in the reference [2].

FIG. 3 depicts a scenario, wherein a mobile terminal supports monitoring of two time slots per frame and thus is not capable of receiving a service requiring three time slots.

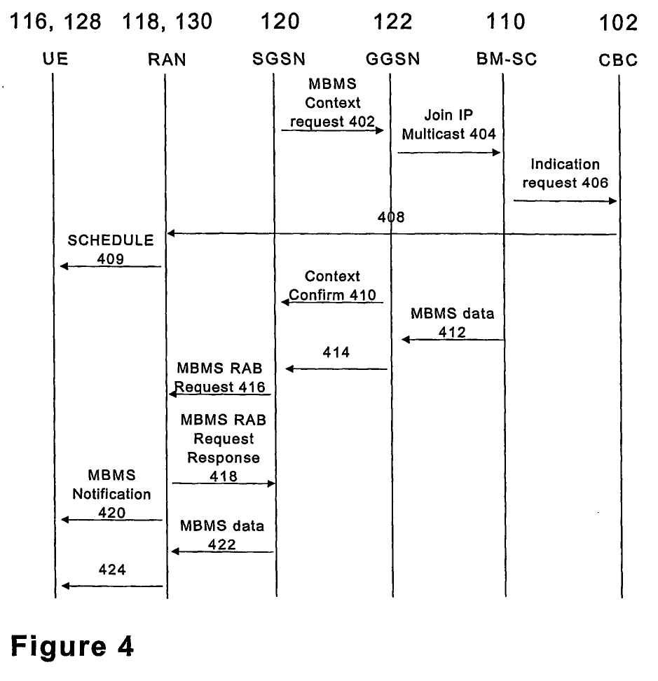

FIG. 4 is a signalling chart disclosing one option for MBMS Broadcast service activation and requirements indication as proposed in a first embodiment of the invention.

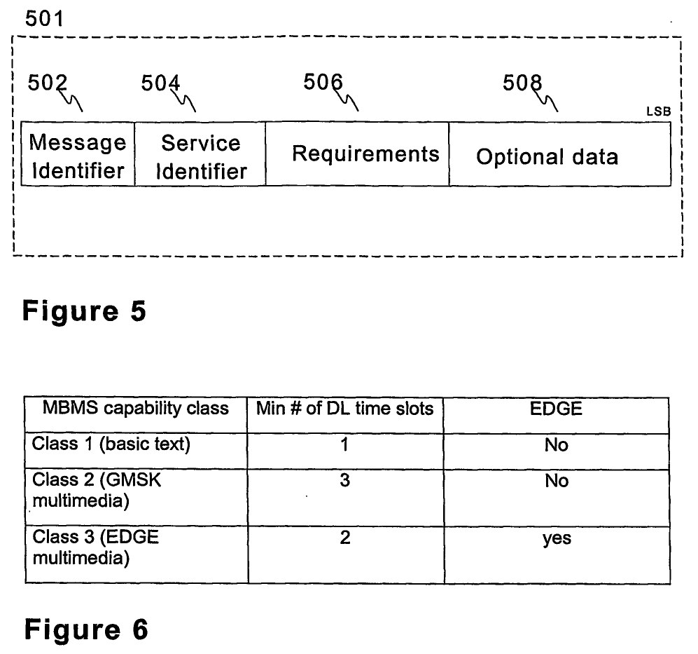

FIG. 5 is an example of an indication request message disclosed in FIG. 4

FIG. 6 illustrates one possible MBMS capability class division according to the first embodiment of the invention.

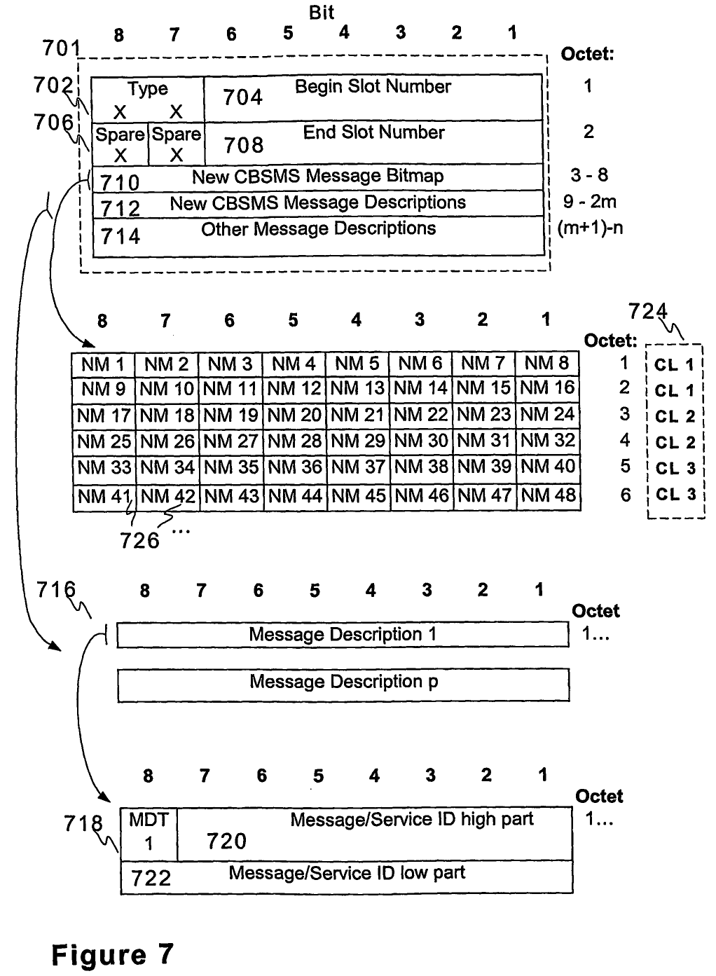

FIG. 7 illustrates a CBS schedule message in accordance with the first embodiment of the invention.

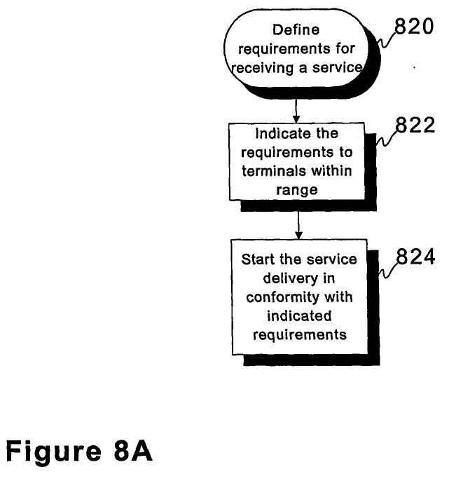

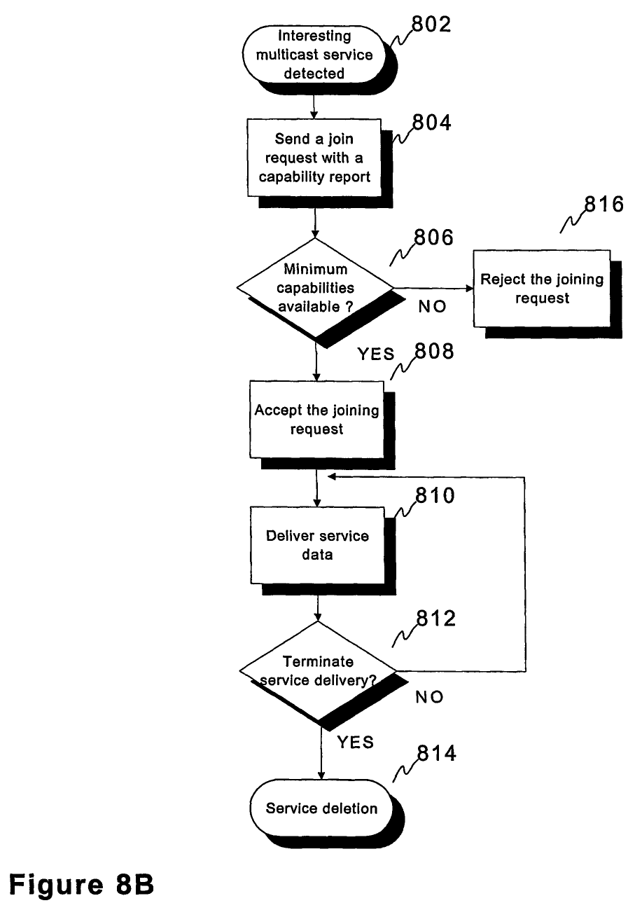

FIG. 8A is a flow diagram disclosing the first embodiment of the invention

FIG. 8B is a flow diagram disclosing a second embodiment of the invention

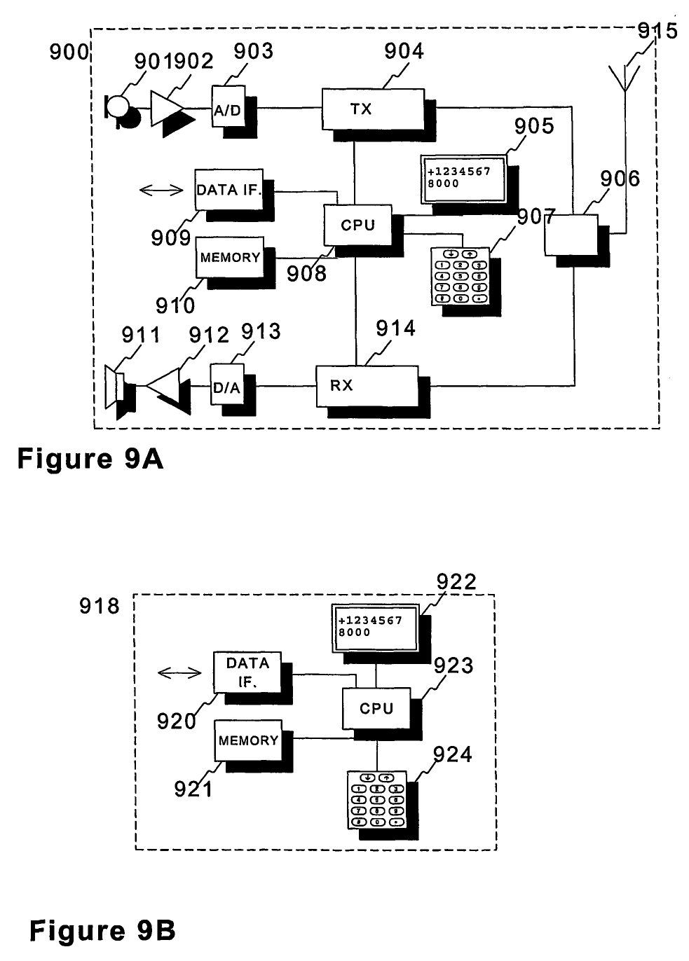

FIG. 9A is a block diagram of a wireless terminal, substantially a cellular phone, capable of sending and receiving broadcast/multicast data according to the invention.

FIG. 9B is a block diagram of a network element capable of sending and receiving broadcast/multicast data according to the invention.

Referring to FIG. 4, a signalling chart for MBMS broadcast service activation with additional requirements indication messaging as proposed in accordance with the invention is illustrated. The procedure is to be performed in a system of FIG. 1 comprising a UMTS (Universal Mobile Telecommunications System) core network and either GERAN 130 or UTRAN 118 as a radio access network. The service data source can be, for example, a multimedia or audio server transmitting tv/radio channels over the network. For example, at a SGSN re-start or when a new MBMS broadcast service is set-up, see phase 402, the SGSN 120 requests a creation of an MBMS context and GTP tunnel on the GGSN 122 for each RNC/BSC (Radio Network Controller, BaseStation Controller) within the service area. In phase 404 the GGSN 122 joins the relevant IP multicast to connect the BM-SC 110 if not connected already. The BM-SC 110 informs the CBC 102 about a need to notify terminals within the service range about the MBMS services including e.g. the requirements for the MBMS service reception, see phase 406. In phase 408 the CBC 102 forwards the indication request to relevant RNC/BSCs that generate schedule messages indicating said services and requirements and broadcast them to the terminals in phase 409. It should be noticed that the aforesaid procedure could also be utilized as a general service announcement 202 (FIG. 2) technique disclosing many other details in addition to the actual requirements for the service reception. Link, reference point and protocol issues concerning the connectivity possibilities between the CBC 102 and other network elements including RNC/BSCs in the radio access networks are not discussed herein in detail and can be found in the reference [4]. In phase 410 MBMS service activation continues normally and GGSN confirms the establishment of the MBMS context. In phase 412 MBMS data is sent to the GGSN 122 and in phase 414 forwarded to the SGSN 120 through all related Gn/Gp tunnels. In phases 416 and 418 a RAB (Radio Access Bearer) is created for each MBMS context utilizing assignment request and assignment response procedures. In phase 420 MBMS notification is sent to terminals being finally followed by the transmission of MBMS service data in phases 422 and 424. Although in this particular embodiment a separate message is constructed for announcing the service information like requirements for the reception, also already existing messages such as the MBMS notification 420 could be used, possibly after some modifications to the present structure of the message, for delivering the same information.

The procedure of indicating the MBMS service requirements and possibly other data in a schedule message may be repeated whenever needed, for example, cyclically. The temporal placement of service requirement indication in connection with MBMS service activation and RAB set-up can vary as well and above-proposed insertion between activation phases 404 and 410 is only a one possible option. Correspondingly, it is noted that the presented procedure as a whole can be considered as an example for clarifying the industrial applicability of the invention, and also other feasible methods exist e.g. for the MBMS service activation/release as presented in the reference [2].

The CBC 102 is responsible for the management of CBS messages. In UMTS the CBC 102 is integrated to as a node into the core network and in GSM it is an external node. The CBC 102 may be connected to several BSCs/RNCs. The CBC's 102 responsibilities include allocation of serial numbers, broadcast initiation, determination of destination cells, broadcast timing and broadcast repetition timing issues, determination of the cell broadcast channels etc. In GSM within a CBC-BSC interface, a CBS message is uniquely identified by the quartet (Message Identifier, Serial Number, Cell Identifier, Channel Indicator). In UMTS within the CBC-RNC interface, a CBS message is uniquely identified by the triplet (Message Identifier, Serial Number, Cell Identifier). See the references [4], [5] and [6] for further information on the technical realization of CBS.

The steps of requesting the indication 406, 408 can be carried out by sending first an indication request message 501, see FIG. 5, to the CBC 102 containing a message identifier describing the type of the message 502, service or context identifier e.g. IP multicast address and APN (Access Point Name) of the service under consideration 504, implicit and/or explicit service requirements 506, and possibly also other optional data such as service delivery goals or “real” schedule data disclosing timing instructions 508. The CBC 102 may forward the message 501 to the relevant RNC/BSCs as such, which can be considered as an addition of a new CBC-RNC/BSC service primitive type or, for example, modify already existing service primitives to include aforesaid message elements to minimize changes needed in existing RNC/BSC interface. For example, WRITE-REPLACE primitive disclosed in [4], which is normally used to broadcast a new CBS message or replace an existing one, can be utilized for this purpose by e.g. selecting a certain message identifier for the indication request procedure and including other necessary information 504, 506 into the parameters of the primitive. Consequently, RNC/BSC software has to be slightly updated in order to receive and execute indication requests. However, changes are modest as a corresponding functionality for handling the primitives already exists.

In this particular embodiment all available MBMS services have been divided into three different MBMS capability classes but in practise, the total number of classes can be selected as desired. Field 506 includes the class parameter of the current service under activation. Classes define the minimum capability required to receive the services properly. A possible scenario with three different classes meant especially for GPRS/EDGE capable terminals and GERAN as a radio access network is presented in FIG. 6.

For each MBMS service that is broadcast over the air interface the system indicates 409 the class of the service i.e. the minimum capability requirements needed for reception. This indication is broadcast in a schedule message so that the receiving UE like a mobile terminal can in advance decide whether to monitor the blocks disclosing the service-related information. The rest of the time the terminal may stay in a low power consumption mode to save battery.

In CBS the system broadcasts schedule messages 701, see FIG. 7, generated by RNC/BSC containing a bitmap 710 of new CB messages that will be broadcast within a predefined period. With this bitmap 710 terminals can in future utilize discontinuous reception (DRX) and listen to only those messages they are interested in and have not yet received. Bitmap 710 comprises one bit for each message slot, wherein each bit refers to the content of the slot being 1 (one) if the slot contains an SMSCB (Short Message Service Cell Broadcast) message which was either not sent during the previous schedule period, or sent unscheduled during the preceding schedule period; or, the message is indicated as of free usage, reading advised. The value is one both for the first transmission of a given SMSCB message page in the schedule period or a repetition of it within the schedule period. Value 0 (zero) means that the definition above does not apply. Schedule message 701 contains a description field 716 for each new (valued 1 in bitmap) CBS message to be broadcast during the scheduling period. For the remaining slots with bitmap value 0 it is also possible to include optional descriptions 714 after obligatory new message descriptions 712. Message slot numbers 726 (1-48) in the bitmap indicate the position of the CBS message within the schedule period. The description describes the content of a message with a message identifier 720, 722, and whether an occurrence is a repetition or not 718 (MDT field, Message Description Type). Message identifier 720, 722 (octet 1 bits 7 to 1 and octet 2 of the message description) structure is defined more exactly in [4]. Each schedule message also includes a Begin Slot Number 704 field and an End Slot Number 708 field. The End Slot Number 708 indicates the length of the schedule period (i.e., specifically the number of CBS message slots about which information is provided). In the case where the network uses schedule messages to describe all message slots in advance, the first schedule message of the next schedule period will be transmitted in the message slot pointed by End Slot Number plus 1. The Begin Slot Number 704 is defined to allow the network to broadcast several Schedule Messages referring to the same schedule period. The Begin Slot Number 704 indicates the message slot number of the CBS message following the received schedule message. The network may send unscheduled schedule messages during empty message slots. The network needs only update the Begin Slot Number 704 in an unscheduled schedule message to reflect the current offset within the schedule message of the next message to be transmitted. Spare bits 706 are normally ignored by the terminals. Type 702 of the schedule message is 00. More details about schedule messaging in CBS can be found in the references [4] and [5].

In this embodiment, a CBS schedule message is exploited as well, but as slightly modified (regarding the field values) it indicates forthcoming, ongoing or both MBMS service transmissions with capability requirements instead of CBS message properties. For example, type 702 and spare 706 fields can be used to mark the message for this MBMS specific purpose. As in the case of the original CBS, schedule message contains as many (new) service descriptions 704 as there are 1-valued bits in the bitmap 702. Optional descriptions may still be used for providing whatever-desired extra information. Regarding MBMS services, in most cases it is not necessary to indicate the service requirements at every turn as what comes to a certain service, the capabilities it requires from the recipient do not probably change very often if at all. Hence, the modified schedule message may be broadcast as a result of changes relating to an activation/release of a new MBMS service, registration/arrival of new terminals in the system/service range, service requirements' change, timing changes etc. or if preferred, on a regular basis as in a normal CBS case. Anyhow, in this example the capability class information is enclosed implicitly as the receiving terminal knows how these MBMS service accouncements are divided in octects based on the capability class division. Therefore, the first two octets of the bitmap 710 provide now information about the upcoming new MBMS services belonging to the first capability class 724 (CL 1). Octets 3 and 4 (messages/services 17-32) are respectively used to indicate class 2 (CL 2) services and octets 5 and 6 (messages/services 33-48) class 3 services (CL3). Thus, the message slot positions 726 (1-48) do not imply the schedule of forthcoming transmissions as in a standard CBS schedule message described in the previous chapter. Message description part 712, 714 still includes IDs 720, 722, but not for occasional message but more like service identification purposes. ID 720, 722 can be e.g. IP multicast address or APN of the corresponding service taken from the indication request 501.

This scheme is simplified and in practise it is possible to give the indication in another way. The capability class can be indicated to terminals explicitly, e.g. by a parameter as 506 in the indication request message 501 by which also slot positions can be exploited for (limited) indication of service scheduling. It is possible to use some other mechanism than the schedule message to indicate the requirements/adequate capability class to the terminal, for example a dedicated message including data about specific or all MBMS services available. Accordingly, the network elements utilized in providing the requirements information for MBMS services do not have to be the ones presented in the examples above as the requirement indication procedure initiator and the following transmission chain components can be varied to better suit different system structures, e.g. depending on the available connections between elements and an availability of elements in general.

To clarify the actual core of the invention even more, a method according to the invention is presented in FIG. 8A. In step 820 requirements for receiving a certain service are defined. They may also be received, for example, from the content provider. Next, the requirements are broadcast to terminals in phase 822. Finally the factual service data is transmitted in conformity with indicated requirements, see phase 824.

In a variant of the embodiment the system informs the terminal about the actual service requirements such as the number of time slots needed for the reception (possibly also modulation: 8PSK, GMSK etc.) without defining any MBMS classes. Naturally this kind of explicit information can be also included in the indication as separate parameters in addition to the explicitly or implicitly defined service class. Recall that with WCDMA terminals and UTRAN radio access network the radio technology differs from the GSM and GERAN case. Thus, the requirements that must be met in order to be able to receive the MBMS service can be different. However, the basic invention works as suggested before, namely that minimum requirements are defined either as classes or explicit requirements (e.g. 128 kbit/s downlink, etc). The same applies for other systems supporting point-to-multipoint transmission like DVB (Digital Video Broadcasting) or WLANs (Wireless LAN).

One detail of the invention is that whenever the service requirements are defined and the system announces them it is also obligated to schedule and transmit the data in a way that the indicated requirements are truly met. For example, if the system has indicated two time slots as a requirement for receiving the service it cannot schedule the data on three time slots.

In the second embodiment of the invention, the overall scenario is much alike the one in the first embodiment. See FIG. 8B for a flow chart, wherein the user of a mobile terminal is willing 802 to join a multicast service by sending 804 a specific message such as a join request to the SGSN 120 or some other preferred network element of the wireless system. Different options for MBMS multicast service activation are presented in the reference [2]. Basically only a few additional steps are needed beyond the phases of MBMS broadcast service activation. The terminal typically requires for a MBMS context on the SGSN that, after creating said context, accepts the context request by sending a separate acknowledgement message back to the terminal. The context request may include the terminal's capability notification formulated, for example, as a set of parameters such as a MBMS capability class, or they may have been stored in the system beforehand in connection with an attach procedure/PDP (Packet Data Protocol) context activation (attach and activation are needed in this case). Anyhow, as the network element in charge, for example the BM-SC 110, knows the terminal's capabilities it can check 806 whether they are sufficient for the service reception or not by e.g. comparing them with the requirements informed by the content provider of the corresponding service. It may then accept/reject the join request depending on the situation; see phases 808 and 816. Service delivery 810 is continued normally, preferably in conformity with indicated requirements, until a reason such as a user request for the service release 812 pops up and the service delivery is ceased 814. So, again there are some requirements that the terminal must meet to receive the service and based on the terminal capabilities a decision is made whether to receive the service or not. However, in this embodiment the decision is made in the system/network side whereas in the earlier solution the decision was made in the terminal.

This invention has been done especially MBMS in mind. However, it could be applied to other cases as well, e.g. to PUSH services, where the network (whatever radio technology) broadcasts/multicasts any data to several terminals which decide whether to receive it or not. Ultimately, regardless of diverse details all services require some sort of properties from the receiving equipment and if a plurality of services exists in a common system, a need for indicating the service specific requirements arises.

Referring to FIG. 9A, basic components of a wireless terminal 900 such as a mobile phone operable in a wireless system and capable of receiving messages including requirements for service reception, sending messages including capability information and activating/deactivating multicast/broadcast services based on received information are presented. Audio parts include a microphone 901, a loudspeaker 911, few amplifiers 902, 912 and transducers 903, 913. Radio parts consist of TX/RX filters with a modulator/demodulator, an amplifier and an antenna necessary for transmitting and receiving the data over an air interface 904, 906, 914, 915. User interface 907 is needed for controlling the device and a display 905 for informing the user about current state and e.g. the memory contents of said device. Processing unit 908 controls the functionalities of the terminal and executes required tasks. A memory 910 chip is needed for program/data storing purposes. An optional wireless data interface 909 enables connections to external devices. An essential power source/battery is not shown in the figure.

Referring to FIG. 9B, a network element 918 operable in a wireless system and capable of sending service requirement indications, receiving capability information and deducing on the basis of said capability information whether the sender is capable of joining a point-to-multipoint service or not is presented. It contains an interface for data transmission 920 with other network entities or wireless terminals, a memory 921 for program/data storing and a processing unit 923 for internal controls and task execution. Optional user interface 924 and display 922 may be used to provide sophisticated control means for the functionalities of the element.

The scope of the invention is disclosed in the following independent claims. However, utilized messages, network elements, system and service specifications etc. may vary depending on the current scenario, still converging to the basic ideas of the invention. Therefore, the invention is not strictly limited to the embodiments described above.

### REFERENCES

[1] 3GPP TS 222.146 V6.0.0 Technical Specification Group Services and System Aspects; Multimedia Broadcast/Multicast Service; Stage 1 Release 6 (2002-6), URL: http://www.3gpp.org, 3GPP 2002
[2] 3GPP TR 23.846 V1.2.0 Technical Specification Group Services and System Aspects; MBMS; architecture and functional description, Release 6 (2002-9), 3GPP 2002
[3] 3GPP TS 45.002 V5.4.0 Technical Specification Group GSM/EDGE Radio Access Network; Multiplexing and multiple access on the radio path, Release 5 (2002-2), 3GPP 2002
[4] 3GPP TS 23.041 V5.0.0 Technical Specification Group Terminals; Technical Realization of Cell Broadcast Service (CBS), Release 5 (2002-06), 3GPP 2002
[5] 3GPP TS 04.12 V8.0.0 Technical Specification Group GSM/EDGE Radio Access Network; SMSCB support on the mobile radio interface, Release 1999 2001-04, 3GPP 2001
[6] 3GPP TS 25.324 V4.1.0 UMTS; Broadcast/Multicast Control BMC, Release 4 (2002-06), 3GPP 2002

What is claimed is:

1. A method for indicating one or more terminal capability requirements for point-to-multipoint MBMS (Multimedia Broadcast/Multicast Service) service reception in a wireless system, characterized in that said method comprises the step of
transmitting a broadcast or multicast message indicating said terminal capability requirements over the air interface to at least one terminal within the service range in order to allow the terminal to determine whether it is capable of receiving the service or not (822), said requirements being indicated in relation to at least one of the following: time slot configuration, modulation type, bit rate, and capability class.

2. The method of claim 1, characterized in that a decision of whether to receive the service or not is made in the terminal on the basis of said indication.

3. The method of claim 1, characterized in that it further comprises a step wherein said requirements for receiving the service are defined (820).

4. The method of claim 1, characterized in that it further comprises a step wherein the service-related data is transmitted in conformity with indicated requirements (824).

5. The method of claim 1, characterized in that said requirements are indicated in said message implicitly with an identifier associated to a certain set of requirements.

6. The method of claim 1, characterized in that said requirements are indicated in said message explicitly with parameters.

7. The method of claim 1, characterized in that said system is substantially GSM (Global System for Mobile communication)/GPRS (General Packet Radio Service) or UMTS (Universal Mobile Telecommunications System) system.

8. The method of claim 1, characterized in that said message is transmitted to the terminals over radio access network.

9. The method of claim 8, characterized in that said radio access network is GERAN (GSM/EDGE Radio Access Network) or UTRAN (UMTS Terrestrial Radio Access Network).

10. The method of claim 1, characterized in that said message is originated by a network element.

11. The method of claim 1, characterized in that said message is sent by the CBC (Cell Broadcast Centre) or RNC/BSC (Radio Network Controller/BaseStation Controller).

12. The method of claim 1, characterized in that said message is substantially a schedule message.

13. The method of claim 12, characterized in that said schedule message is CBS (Cell Broadcast Service) service specific.

14. The method of claim 1, characterized in that said message is a discrete indication message.

15. A method for indicating requirements for point-to-multipoint MBMS (Multimedia Broadcast/Multicast Service) service reception in a wireless system to be performed by a terminal operable in said system, characterized in that said method comprises the step of
informing the terminal's capabilities in relation to at least one of the following: time slot configuration, modulation type, bit rate, and capability class, to said system in order to enable the system to deduce on the basis of the informed data whether the terminal is capable of receiving the service or not (804).

16. The method of claim 15, characterized in that it further comprises a step (806) wherein the system either accepts or rejects the terminal's join request based on said deduction.

17. The method of claim 15, characterized in that said system is substantially GSM (Global System for Mobile communication)/GPRS (General Packet Radio Service) or UMTS (Universal Mobile Telecommunications System) system.

18. The method of claim 15, characterized in that said informing is performed over a radio access network that is substantially GERAN (GSM/EDGE Radio Access Network) or UTRAN (UMTS Terrestrial Radio Access Network).

19. The method of claim 15, characterized in that said informed data indicates at least one of the following features supported by said terminal: time slot configuration, modulation type, bit rate, and capability class.

20. The method of claim 15, characterized in that it further comprises a step wherein the service-related data is transmitted in conformity with indicated requirements (810).

21. The method of claim 16, characterized in that said point-to-multipoint service is substantially a multicast service.

22. The method of claim 16, characterized in that the air interface in said system is substantially in accordance with DVB (Digital Video Broadcasting) or WLAN (Wireless Local Area Network) specifications.

23. A terminal (900) operable (904, 906, 914, 915) in a wireless system, comprising processing means (908) and memory means (910) for processing and storing instructions and data, characterized in that said terminal is arranged to receive a message indicating requirements for point-to-multipoint MBMS (Multimedia Broadcast/Multicast Service) service reception and further arranged to determine on the basis of said requirements whether it is capable of receiving the service or not, said requirements indicated in relation to at least one of the following: time slot configuration, modulation type, bit rate, and capability class.

24. The terminal of claim 23, characterized in that it is arranged to specify said requirements indicated in said message by associating at least one identifier included in said message to a certain set of requirements.

25. The terminal of claim 23, characterized in that it is arranged to extract said requirements directly from said message wherein said requirements are described explicitly.

26. The terminal of claim 23, characterized in that said message to be received is a point-to-multipoint message.

27. The terminal of claim 23, characterized in that it is substantially a GSM (Global System for Mobile communication) or UMTS (Universal Mobile Telecommunications System) terminal.

28. The terminal of claim 23, characterized in that it is arranged to extract said indications of service requirements from a schedule message.

29. The terminal of claim 23, characterized in that it is arranged to receive said message from the system over the air interface congruent with DVB (Digital Video Broadcasting) or WLAN (Wireless Local Area Network) specifications.

30. A terminal (900) operable (904, 906, 914, 915) in a wireless system, comprising processing means (908) and memory means (910) for processing and storing instructions and data, characterized in that it is arranged to inform its capabilities in relation to at least one of the following: time slot configuration, modulation type, bit rate, and capability class, to said system for the examination of fulfilment of point-to-multipoint MBMS (Multimedia Broadcast/Multicast Service) service reception requirements.

31. The terminal of claim 30, characterized in that said informing is to be included in a join request for a multicast service.

32. The terminal of claim 30, characterized in that it is substantially a GSM (Global System for Mobile communication) or UMTS (Universal Mobile Telecommunications System) terminal.

33. A network element (918) operable (920) in a wireless system, comprising processing means (923) and memory means (921) for processing and storing instructions and data, characterized in that it is arranged to send a message indicating requirements in relation to at least one of the following: time slot configuration, modulation type, bit rate, and capability class, for point-to-multipoint MBMS (Multimedia Broadcast/Multicast Service) service reception to be delivered to at least one wireless terminal within the service range in order to allow said wireless terminal to determine whether it is capable of receiving the service or not.

34. The network element of claim 33, characterized in that said message to be sent is a point-to-multipoint message.

35. The network element of claim 33, characterized in that it is arranged to define said requirements for receiving said point-to-multipoint service.

36. The network element of claim 33, characterized in that it is arranged to receive said requirements for point-to-multipoint service reception prior to indicating them.

37. The network element of claim 33, characterized in that it is arranged to insert said indication of requirements into said message by at least one identifier associated to a certain set of requirements.

38. The network element of claim 33, characterized in that it is arranged to insert said indication of requirements into said message explicitly by at least one parameter.

39. The network element of claim 33, characterized in that said it is arranged to operate in a GSM (Global System for Mobile communication)/GPRS (General Packet Radio Service) or UMTS (Universal Mobile Telecommunications System) system.

40. The network element of claim 33, characterized in that it is arranged to transmit said message to be delivered over radio access network.

41. The network element of claim 40, characterized in that said radio access network is GERAN (GSM/EDGE Radio Access Network) or UTRAN (UMTS Terrestrial Radio Access Network).

42. The network element of claim 33, characterized in that it is substantially the CBC (Cell Broadcast Centre).

43. The network element of claim 33, characterized in that said message to be sent is substantially a schedule message.

44. The network element of claim 33, characterized in that said message to be sent is a discrete indication message.

45. The network element of claim 33, characterized in that said point-to-multipoint service is substantially a broadcast or multicast service.

46. The network element of claim 33, characterized in that the air interface in said system is substantially in accordance with DVB (Digital Video Broadcasting) or WLAN (Wireless Local Area Network) specifications.

47. A network element (918) operable (920) in a wireless system, comprising processing means (923) and memory means (921) for processing and storing instructions and data, characterized in that it is arranged to receive a notification from a terminal in relation to at least one of the following: time slot configuration, modulation type, bit rate, and capability class, and deduce on the basis of said notification whether the terminal is capable of receiving a point-to-multipoint MBMS (Multimedia Broadcast/Multicast Service)service or not.

48. The network element of claim 47, characterized in that it is arranged to accept or reject the terminal's join request based on said decision.

49. The network element of claim 47, characterized in that said point-to-multipoint service is substantially a multicast service.

50. The network element of claim 47, characterized in that the air interface in said system is substantially in accordance with DVB (Digital Video Broadcasting) or WLAN (Wireless Local Area Network) specifications.

51. A system comprising a network element (918) and at least one wireless terminal (900) operable in said system, characterized in that said network element (918) comprises means (920) for sending a message indicating requirements for point-to-multipoint MBMS (Multimedia Broadcast/Multicast Service) service reception in relation to at least one of the following: time slot configuration, modulation type, bit rate, and capability class, to be delivered to at least said wireless terminal (900) within the service range and said terminal (900) comprises means (906, 914, 915, 910) for receiving said broadcast message indicating requirements for point-to-multipoint service reception and means (908) for determining on the basis of said requirements whether it is capable of receiving the service or not.

52. The system of claim 51, characterized in that said message to be sent is a point-to-multipoint message.

53. The system of claim 51, characterized in that said network element (918) further comprises means (923) for defining said requirements for point-to-multipoint service reception.

54. The system of claim 51, characterized in that said network element (918) further comprises means (920) for receiving said requirements for point-to-multipoint service reception prior to sending said message indicating said requirements.
